(19) United States
(12) Patent Application Publication
(10) Pub. No.: US 2012/0322524 A1
(43) Pub. Date: Dec. 20, 2012

(54) GAME MACHINE AND STORAGE MEDIUM

(75) Inventors: Yoshihisa INOUE, Minato-ku (JP); Masakazu SHIBAMIYA, Minato-ku (JP)

(73) Assignee: KONAMI DIGITAL ENTERTAINMENT CO., LTD., Tokyo (JP)

(21) Appl. No.: 13/493,359

(22) Filed: Jun. 11, 2012

(30) Foreign Application Priority Data
Jun. 14, 2011 (JP) 2011-132426

(51) Int. Cl. A63F 13/04

(52) U.S. Cl. 463/5

(57) ABSTRACT

In a direction determination portion which determines a shooting direction of a bullet based on a direction instructed from a gun controller, the direction determination portion detects a position of a enemy object in the direction instructed from the gun controller and controls a shift between the position of the enemy object and the shooting direction of the bullet based on the direction instructed from the gun controller.

### CROSS REFERENCE TO RELATED APPLICATION

This application claims priority to Japanese Patent Application No. 2011-132426, filed Jun. 14, 2011, the disclosure of which is hereby incorporated by reference in its entirety.

### TECHNICAL FIELD

The present invention relates to a game machine which executes a game which proceeds according to whether or not a bullet hits a target.

### BACKGROUND ART

There has been well known a game machine which executes a shooting game which proceeds by shooting a bullet to a target e.g., an enemy character, for bringing down the enemy character (for instance, see Patent literature 1). Patent Literature 1 JP-A-2005-253724.

### SUMMARY OF INVENTION

### Technical Problem

In the shooting game, a position aimed by a player is indicated by a cursor having a certain degree of size, and a bullet is then shot toward the center of the cursor. In the case of a beginner player, when a bullet is aimed at and is then shot toward a target, the target is often shifted from the center of the cursor and cannot be hit by the bullet, resulting in spoiling the enjoyment in the game. On the other hand, an advanced player prefers a game at high difficulty level, so that an actual bullet shooting direction is required to be flexibly controlled.

Thus, the present invention aims to provide a game machine capable of controlling a shooting direction of a bullet flexibly and a storage medium.

### Solution to Problem

The game machine of the present invention is a game machine comprising: a direction determination device which determines a shooting direction of a bullet based on a direction instructed from an input device; wherein the direction determination device has a position detection device which detects the position of a target in the direction instructed from the input device, and a shift controlling device which controls a shift between the position of the target detected by the position detection device and the shooting direction of the bullet based on the direction instructed from the input device.

According to the game machine of the present invention, when the position of the target to be shot is shifted from the direction instructed, the shift is controlled by determining the actual shooting direction of the bullet based on the position of the target and the direction instructed from the input device. For instance, when the target is shifted from the direction aimed by the player for shooting the target, the shooting direction of the bullet can be controlled to be directed to the position of the target or a bullet can be controlled to be bad shot even when the target is present in the direction instructed from the input device. Therefore, it is possible to give the feeling of satisfaction in game play to the player and to enhance the enjoyability of the game by controlling the shooting direction of the bullet flexibility according to purpose. It should be noted that the “direction” used herein also includes the concept of a “position”. The shift of the “direction” in which a bullet is shot is controlled in the present invention, but the “direction” can also be considered as a “position” into which a bullet is shot, as a focus. Therefore, the present invention is also applicable to a two-dimensional space as well as to a three-dimensional space.

As one aspect of the game machine of the present invention, the shift controlling device operates to eliminate the shift by setting a direction in which the target is positioned, as a reference direction, based on the position of the target and the direction instructed from the input device and determining the shooting direction of the bullet based on the reference direction. According to this, when the direction instructed by the player for aiming at the target is shifted from the direction in which the target is positioned, the direction in which the target is positioned is determined as the reference direction to shoot a bullet in the reference direction. Thereby, even when the bullet shot in the direction instructed by the player misses the target, it can hit the target, so that the feeling of satisfaction in bullet hit can be given to the player.

As one aspect of the game machine of the present invention, the direction determination device generates a shot range of a predetermined size, centered on a base point on the direction instructed from the input device, and when the target is present in the shot range, the position detection device detects the position of the target. According to this, the shot range is determined based on the direction instructed from the input device, and if the target is present in the shot range, the position of the target is detected, thereby controlling the shift between the direction in which the target is positioned and the instructed direction. Since the shot range is determined based on the instructed direction, the possibility that the target in the shot range is aimed by the player is high, so that the shift between the direction in which the target is positioned and the instructed direction is controlled to enable the shooting direction of the bullet to be flexibly controlled.

In the aspect in which the shot range is generated, the position detection device detects the position of the target which is present in the shot range when the player shoots a bullet. According to this, the bullet is shot toward the position in which the target is present when the player shoots the bullet. The bullet is simply shot into the position in which the target is present at that time, and when the target moves after the bullet is shot, the bullet cannot hit the target. Further, in the aspect in which the shot range is generated, the position detection device detects the position of the target which is closest to a position of a character operated by the player when a plurality of targets is present in the shot range. According to this, when a plurality of targets is present in the shot range, the target which is closest to the character operated by the player is selected, so that the bullet can be performed to naturally hit the target.

In the aspect in which the shot range is generated, the direction determination device changes the size of the shot range based on game data showing the skill degree of the player. According to this, the size of the shot range is changed according to the skill degree of the player, so that the difficulty level according to player can be set more finely to enable the enjoyment in the game to be increased.

In the aspect which determines the direction in which the target is positioned as the reference direction, the direction determination device further has an accuracy calculation device which calculates accuracy which represents the shooting direction of the bullet as a probability distribution in the reference direction. According to this, the accuracy is calculated in the reference direction, so that the shooting direction of the bullet is shifted from the reference direction. It is possible to diversify the game properties and to enhance the enjoyability of the game by calculating the accuracy differently according to the state of the game.

A storage medium of the present invention is a storage medium storing a computer program for a computer of a game machine to function as: a direction determination device which determines a shooting direction of a bullet based on a direction instructed from an input device; a position detection device which detects the position of a target in the direction instructed from the input device; and a shift controlling device which controls a shift between the position of the target detected by the position detection device and the shooting direction of the bullet based on the direction instructed from the input device. It is possible to function as a game machine of the present invention by executing the program of the present invention on the computer of the game machine.

### Advantageous Effects of Invention

As described above, according to the present invention, when the position of the target to be shot is shifted from the direction instructed, the shift is controlled by determining the actual shooting direction of the bullet based on the position of the target and the direction instructed from the input device. It is possible to give the feeling of satisfaction in game play to the player and to enhance the enjoyability of the game by controlling the actual shooting direction of the bullet flexibility according to purpose.

### BRIEF DESCRIPTION OF DRAWINGS

FIG. 1 is a block diagram of a game machine according to one aspect of the present invention.

FIG. 2 is a function block diagram of a direction determination portion.

FIG. 3 is a diagram showing an example of a game screen displayed on a monitor.

FIG. 4 is a diagram showing a virtual three-dimensional space corresponding to a main image of FIG. 3.

FIG. 5 is a flowchart showing a direction determination processing routine executed by a control unit.

### DESCRIPTION OF EMBODIMENTS

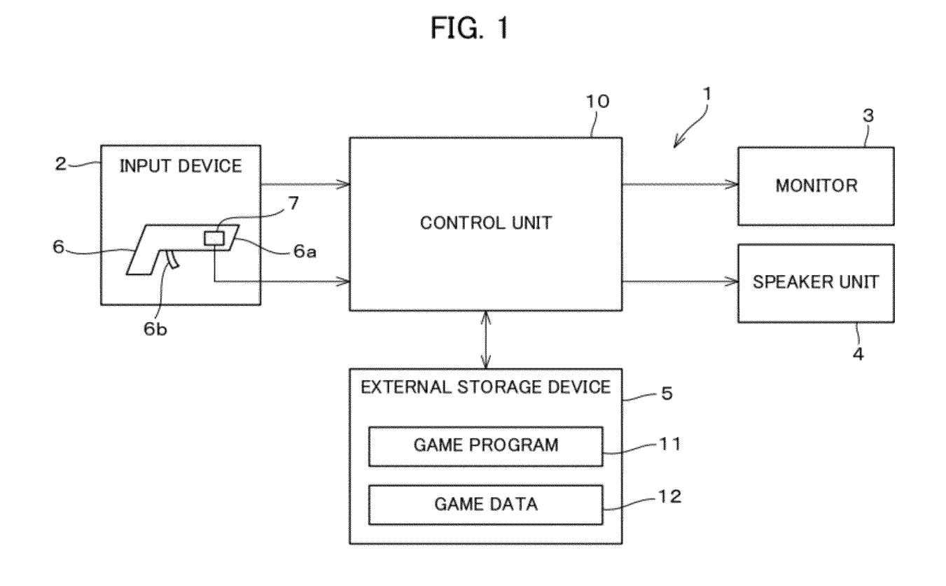

FIG. 1 shows a block diagram of a game machine according to one aspect of the present invention. The game machine of this embodiment provides an action type game in which a player operates a character set to be operated (sometimes called a player character) to search an virtual game space for gaming according to whether or not a predetermined mission can be performed. The game machine may be a business use game machine to be installed in a commercial facility, or may be a home use game machine. A game machine 1 has a control unit 10. The control unit 10 is a computer unit in which a microprocessor and a peripheral device such as main memory (RAM and ROM) necessary for its operation are combined. The control unit 10 is connected to a input device 2 for a game, a monitor (as an example, a liquid crystal display device) 3, a speaker unit 4, and an external storage device 5, respectively. In addition, the control unit 10 can be connected to various peripheral devices. However, these are not shown.

The input device 2 includes a plurality of operating portions (not shown) which receives the operations of the player, and issues signals corresponding to the operations of those operating portions to the control unit 10. The input device 2 includes a gun controller 6 which is similar to a gun. The gun controller 6 is provided as an input device which represents a weapon provided to the player. The player can shoot a target displayed on the screen of the monitor 3, as needed, by directing a muzzle 6a of the gun controller 6 to the target to operate a trigger lever 6b. The gun controller 6 is equipped with a focus detection sensor 7 which detects to what position on the screen of the monitor 3 the muzzle 6a is directed.

Various well-known sensors can be used as the focus detection sensor 7. As an example, a sensor which receives infrared light emitted from a plurality of positions around the target to be observed (monitor 3) toward the observer (player) by a light receiving portion provided on the observer side, and detects, based on the light received state, a direction of the light receiving portion, can be used as the focus detection sensor 7. Or a direction of the muzzle 6a may be detected by providing a camera around the monitor 3 to process an image taken by the camera. Further, the direction of the muzzle 6a may be detected by using various sensors such as a gyro sensor, a magnetic field sensor, and acceleration sensor.

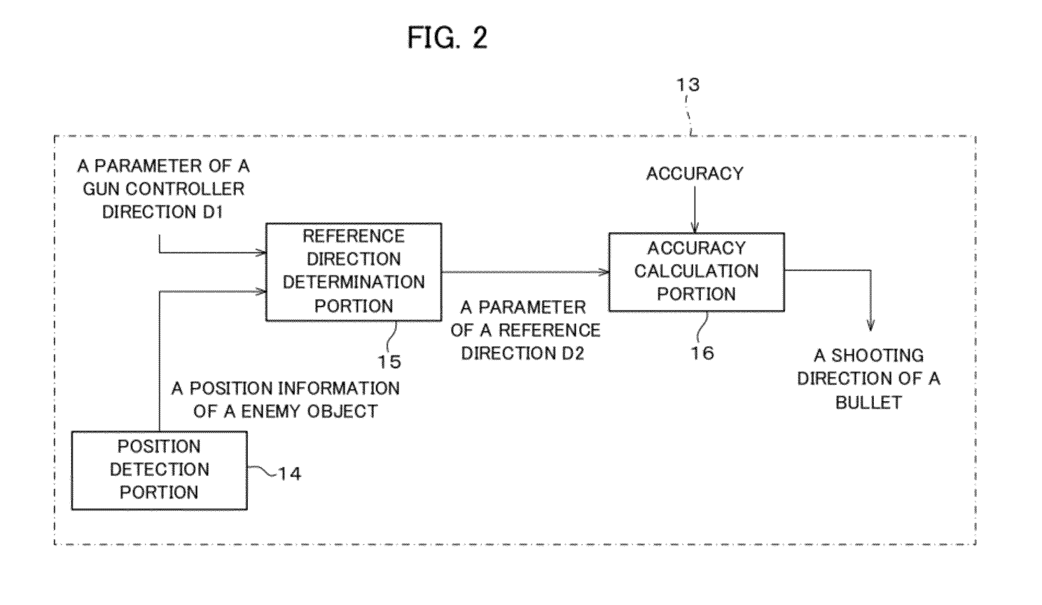

The external storage device 5 is a storage device including a non-volatile storage medium such as a magnetic storage medium, an optical storage medium, and an EEPROM. In the external storage device 5, an operating system for realizing the basic control of the control unit 10, a game program 11 as application software for executing the game by a predetermined procedure, and game data 12 referred by the game program 11, are stored as needed. In the control unit 10, various logic devices necessary for executing the game are generated by reading and executing the game program 11. And control unit 10 executes various calculations processing necessary for the proceeding of the game executed by the game machine 1. As one of the logic devices, a direction determination portion 13 is generated in the control unit 10. FIG. 2 shows a function block diagram of the direction determination portion 13. The direction determination portion 13 determines a shooting direction of a bullet based on a direction in which the gun controller 6 is directed, and includes a position detection portion 14, a reference direction determination portion 15, and an accuracy calculation portion 16. The direction determination portion 13, the position detection portion 14, the reference direction determination portion 15, and the accuracy calculation portion 16 will be described later in detail.

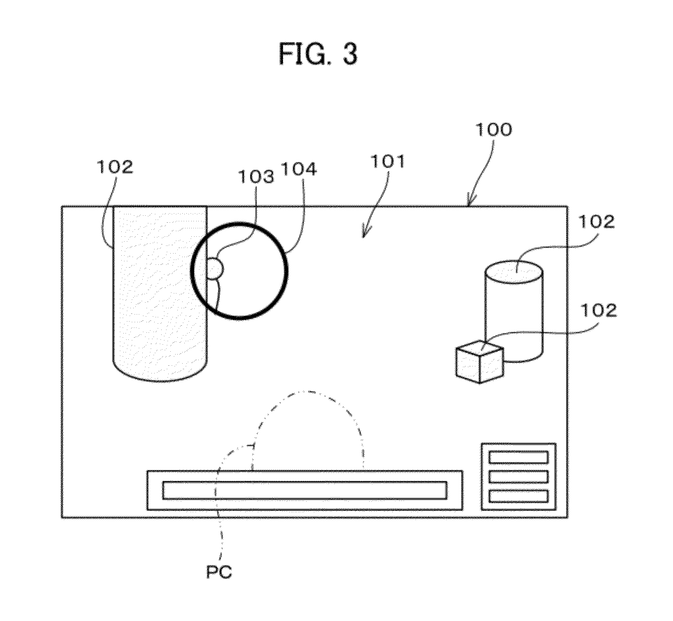

FIG. 3 is a diagram showing an example of a game screen displayed on the monitor 3. A game screen 100 displays a main image 101 showing the state of a game space indoors and the like set as a place in which a player character PC moves. On the main image 101, an installed object 102 such as a pillar and a box is put in the game space, and an enemy object 103 as the target moves in the game space. As the enemy object 103, various objects such as a human, an animal, and a vehicle are targeted. The enemy object 103 is operated by the control unit 10 so as to attack the player character PC by a weapon that the enemy object 103 has. Or the enemy object 103 may be operated by the player of a different game machine connected to the game machine 1 via the network. The player character PC may be displayed on the main image 101 or may be omitted.

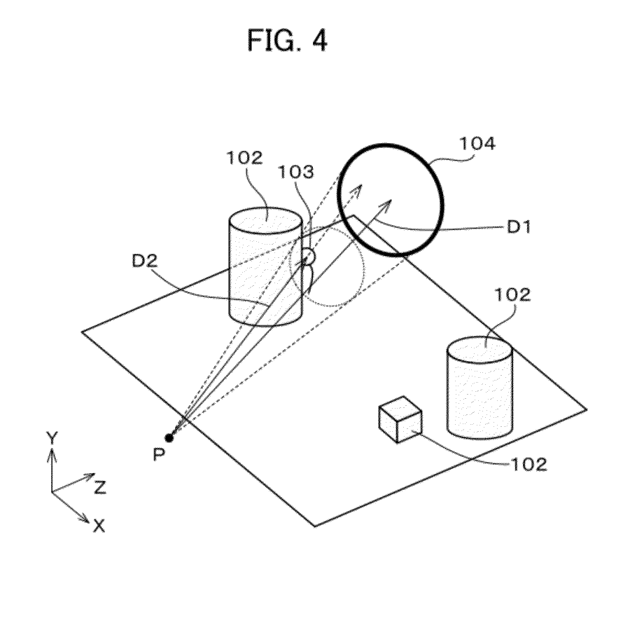

When the player directs the gun controller 6 to the game screen 100, a cursor 104 as a shot range of a predetermined size, centered on the focused position (not shown) detected by the focus detection sensor 7, is displayed. The size of the cursor 104 is set to be different for each weapon used by the player character PC. When the enemy object 103 is present in the cursor 104, the position of the enemy object 103 is detected to shoot a bullet toward the enemy object 103. At this time, the bullet is shot in a shooting direction of the bullet obtained by calculating accuracy with respect to the parameter of a reference direction D2 (see FIG. 4). The reference direction D2 is the direction which is the reference of the shooting direction of the bullet, and will be described later in detail.

Like the size of the cursor 104, the accuracy is set to be different for each weapon. The accuracy is shown as the distribution of a shooting direction of the bullet, centered on the reference direction D2, and is influenced by ease of bullet hit. When the accuracy is low, the shooting direction of the bullet is shifted from the reference direction D2, and when the accuracy is high, the shooting direction of the bullet is focused onto the reference direction D2. Further, the accuracy is changed according to the operation state of the player character PC, e.g., to whether or not the player character PC is moving or whether or not the player character PC is sitting down on its heels, and to the operation mode whether or not the point at which the player's eyes are directed is fixed. When the player character PC is moving, the accuracy is lower than that when the player character PC is stopping. And when the player character PC is sitting down on its heels, it is easily aimed at, so that the accuracy is set to be higher. In addition, when the point at which the player's eyes are directed is fixed, it is easily aimed at, so that the accuracy is set to be higher.

The main image 101 is an image which displays a virtual three-dimensional space from the point at which the player's eyes are directed. FIG. 4 shows the virtual three-dimensional space corresponding to the main image 101 of FIG. 3. The cursor 104 indicated on the main image 101 is displayed in plain view, but actually, the size of the cursor 104 radially spread, centered on an axis along a direction D1 in which the muzzle 6a is directed, is determined to have a predetermined size based on a position P in the three-dimensional space of the weapon that the character player PC has, that is, the muzzle 6a of the gun controller 6, as a base point, and the axis along a direction D1. If the enemy object 103 is present in the cursor 104, the reference direction D2 is determined toward the enemy object 103. Including the determination of the reference direction D2, the shooting direction of the bullet is determined by the direction determination portion 13. The direction D1 in which the muzzle 6a of the gun controller 6 is directed corresponds to a direction instructed by the input device.

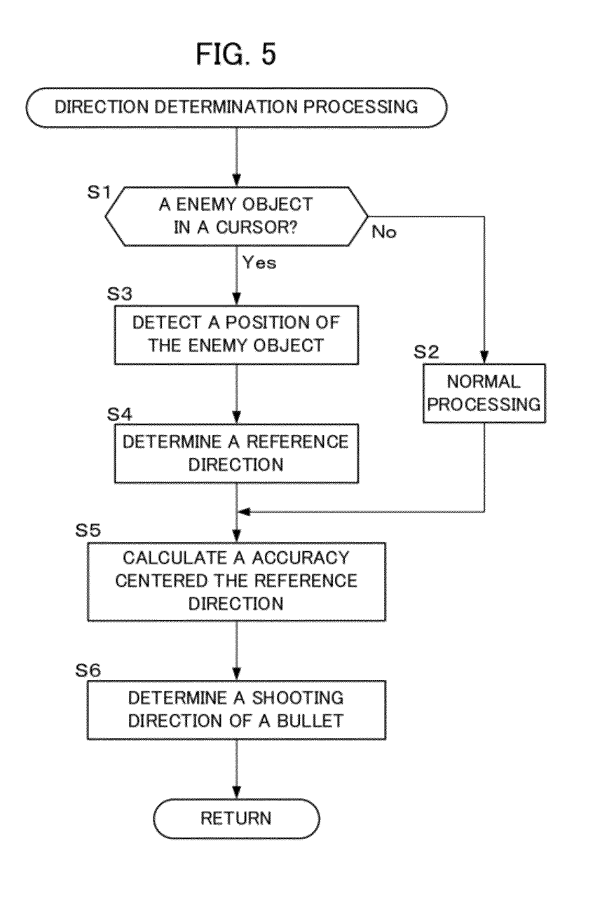

FIG. 5 is a flowchart showing a direction determination processing routine. The direction determination processing is a processing routine which is repeated during the execution of the game, and determines the shooting direction of the bullet shot by the player. In the step S1, the control unit 10 determines whether or not the enemy object 103 is present in the cursor 104. When the enemy object 103 is not present in the cursor 104, the control unit 10 goes to the step S2 to execute the normal processing. When the enemy object 103 is not present in the cursor 104, as the normal processing, the direction D1 in which the gun controller 6 is directed is determined as the reference direction D2. Then, the control unit 10 goes to the step S5. When the player shoots the bullet, the shooting direction of the bullet is determined according to the accuracy defined by the weapon used and the operation state, centered on the reference direction D2.

When the enemy object 103 is present in the cursor 104 in the step S1, the control unit 10 goes to the step S3 to detect the position of the enemy object 103. As the position of the enemy object 103, when a targeted position which is previously defined for each enemy object 103 is present in the cursor 104, the targeted position may be detected, and when part of the enemy object 103 enters into the cursor 104, the center position with respect to the part may be calculated and detected. The position detection may be changed according to the specifications of the game, as needed. The position of the enemy object 103 detected here is detected based on the state that the bullet is shot. Further, when a plurality of enemy objects 103 are present in the cursor 104, the position of the enemy object 103 which is closest to the player character PC is selected. The present invention is not limited to this, and when a plurality of enemy objects 103 are present in the cursor 104, any one of them may be selected.

In the next step S4, the control unit 10 calculates the reference direction D2 based on the position detected in the step S3. The position P of the muzzle 6a and the position of the enemy object 103 are connected to calculate the reference direction D2. Thereby, the reference direction D2 is determined in the cursor 104. The control unit 10 goes to the step S5, and calculates the accuracy with respect to the reference direction D2 set in Step S4. For instance, in the case of a weapon like a shotgun, the accuracy having a distribution in which the direction from the position P is spread, centered on the reference direction D2, is set. And in the case of a weapon like a rifle, the accuracy having a distribution in which the direction from the position P is focused onto the reference direction D2 is set. The accuracy is represented in the probability distribution in the shooting direction of the bullet, centered on the reference direction. The accuracy set for each of the weapons used, which is added with the operation state of the player is calculated with respect to the bullet shot by the player. The accuracy represents the shift of the bullet shooting direction due to the weapon and the operation state. Then, in the step S6, the control unit 10 determines the shooting direction of the bullet based on the result calculated in the step S5. After in the step S5, the accuracy is calculated, centered on the reference direction D2, the bullet is shot toward the direction centered on the reference direction D2 (actually, since the accuracy is calculated, the shooting direction of the bullet is shifted, centered on the reference direction D2, with the result that there is a possibility that the shooting direction of the bullet cannot coincide with the reference direction D2). Then, the control unit 10 ends this processing.

According to the above processing, when the enemy object 103 is present in the cursor 104 (the step S1), the position of the enemy object 103 is detected (the step S3), and the reference direction D2 is determined based on the position (the step S4). Then, the accuracy is calculated, centered on the reference direction D2 (the step S5), and then, the shooting direction of the bullet is determined based on the result (the step S6). When the enemy object 103 is not present in the cursor 104, the normal processing is executed (the step S2), the accuracy is calculated, centered on the determined direction (the step S5), and the shooting direction of the bullet is determined (the step S6). The steps S5 and S6 are executed when the player directs the muzzle 6a of the gun controller 6 toward the game screen 100 and operate the trigger lever 6b during the execution of the game, and the steps S1 to S4 are processed at all times during the execution of the game to be shot regardless of the presence or absence of the operation of the trigger lever 6b. The processing timing of the direction determination processing is not limited to the processing timing described here. For instance, all the processing of the steps S1 to S6 are executed at the time of the operation of the trigger lever 6b, so that the direction determination processing may be processed at the appropriate timing according to game design and processing ability.

In the direction determination processing, the step S3 corresponds to the position detection portion 14, the steps S2 and S4 correspond to the reference direction determination portion 15, and the step S5 corresponds to the accuracy calculation portion 16. Referring to the function block diagram of FIG. 2, the reference direction determination portion 15 determines the reference direction D2 with reference to the parameter of the direction D1 in which the gun controller 6 is directed and the position information of the enemy object 103 determined by the position detection portion 14, and the accuracy calculation portion 16 calculates the accuracy determined based on the parameter of the reference direction D2 and the bullet shooting conditions, that is, the weapon used and the operation state, to determine the shooting direction of the bullet. The step S3 serves as position detection device, the step S4 (reference direction determination portion) serves as shift controlling device, and the step S5 serves as the accuracy calculation device.

Conventionally, when a bullet is shot to the enemy object 103 which is present in the cursor 104 but is shifted from the center of the cursor 104, the hit probability is low since the reference direction D2 is set in the direction in which the gun controller 6 is directed, that is, in the direction toward the focused position at the center of the cursor 104. In this embodiment, since the reference direction D2 is determined toward the position of the enemy object 103, the hit probability becomes high. In particular, in the case of a beginner player, even when the enemy object 103 is positioned to be shifted from the center of the cursor 104, a shot bullet is directed in the direction of the enemy object 103, so that the feeling of satisfaction in shooting the enemy object 103 can be obtained and that the enjoyment in the game cannot be spoiled.

The present invention is not limited to the above embodiment and can be realized in various kinds of embodiments. For instance, in this embodiment, the reference direction D2 is determined with reference to the position information of the enemy object 103, but the present invention is not limited to this. For instance, the reference direction D2 may be determined to be shifted from the enemy object 103 which is present in the cursor 104. According to the state of the player character PC and the characteristic of the weapon being used, the reference direction D2 may be determined with reference to the position information of a position apart from the position of the enemy object 103 by a predetermined distance in a predetermined direction. In that case, the shooting direction of the bullet can be determined with reference to the direction D1 in which the gun controller 6 is directed and the position information of the enemy object 103. The reference direction D2 may be determined by predicting a shot position, not only from the position information of the enemy object 103, but also from a moving speed, a moving direction, a bullet shooting position, and a bullet moving speed. When the shooting direction of the bullet is determined, the accuracy is calculated in the step S5, but the accuracy is not always required to be calculated. Unless the accuracy is calculated, a bullet is shot toward the reference direction D2. The gun controller 6 has been described as the input device, but the present invention is not limited to this. For instance, the direction may be instructed by a controller having a cross key or a controller having an operating lever. The input device having various shapes is applicable.

In the above embodiment, the direction or the position indicated by the reference direction D2 is not displayed on the game screen 100, but the present invention is not limited to this and the direction or the position indicated by the reference direction D2 may be displayed. For instance, a small cursor indicating the reference direction D2 may be displayed on the enemy object 103 on the main image 101 of FIG. 3. When the small cursor is displayed, the feeling of capturing the enemy object 103 can be given to the player. When the small cursor is displayed, the position of the enemy object 103 should be detected each time the enemy object 103 enters into the cursor 104 to display the small cursor in that position. Further, in this embodiment, the present invention has been described with the shooting game in which the player character PC moves in the three-dimensional space, but the present invention is not limited to this and is applicable to the game formed in a two-dimensional space. A cursor including the direction to be aimed, instructed by the player, should be displayed, and when the enemy object is present in the cursor, the position of the enemy object should be determined as the reference direction. In that point, the three-dimensional space and the two-dimensional space are not different in embodying the present invention.

Further, the size of the cursor 104 may be changed, as needed. For instance, a player who is not skilled in the game has a low game level and a low hit probability of the bullet, so that based on the game data 12 describing those data, when the skill degree of the player is low, the size of the cursor 104 may be changed to be larger. On the contrary, for a player who is skilled in the game, the size of the cursor 104 may be changed to be smaller based on the game data 12. The size of the cursor 104 can be changed, as needed, according to the skill degree of the player. The cursor 104 is the guide of the shooting direction of the bullet shown to the player, so that the inside of a range smaller than the range indicated by the cursor 104 may be used in the step S1 for determining whether or not the enemy object 103 is present therein and that on the contrary, the inside of a range larger than the range indicated by the cursor 104 may be used in the step S1 for determining whether or not the enemy object 103 is present therein. The targeted range is not always required to be shown to the player, and is not required to be displayed on the game screen 100. In that case, a range used for determining whether or not the enemy object 103 is present therein may be set, or the entire range displayed on the main image 101 may be used for determining whether or not the enemy object 103 is present therein. A range used for determining whether or not the enemy object 103 apart from the cursor 104 and the range indicated by the cursor 104 is present therein can be changed, as needed, according to the difficulty level of the game and the skill degree of the player.

The detection of the position of the enemy object 103 has been described in the step S3 of the direction determination processing, but in this case, even when the enemy object 103 moves after the position of the enemy object 103 is detected, that is, after the player operates the trigger lever 6b, a bullet cannot follow the direction of the enemy object 103 and cannot hit the enemy object 103. The present invention is not limited to such a embodiment, and for instance, a bullet may follow the enemy object 103. At the time of using a weapon in which a bullet follows the enemy object 103 or of setting for a game beginner, the detection of the position of the enemy object 103 whose position is detected in the step S3 may be continued to change a bullet moving direction based on the position. In this case, only the detection of the enemy object 103 in the cursor 104 may be performed in the step S3.

Further, in the direction determination processing, the position of the enemy object 103 inside and outside the cursor 104 is detected to determine the reference direction D2 (the steps S1 to S4), and then, the accuracy is calculated (the step S5) to determine the shooting direction of the bullet (the step S6), but the present invention is not limited to this. For instance, the processing of the step S5 may be performed first to calculate the accuracy, after a shift state with respect to the reference direction D2 to be determined may be determined, the processing of Steps S1 to S4 may be performed. The order of the processing can be changed, as needed.

What is claimed is:

1. A game machine comprising:
a direction determination device which determines a shooting direction of a bullet based on a direction instructed from an input device; wherein
the direction determination device has a position detection device which detects the position of a target in the direction instructed from the input device, and a shift controlling device which controls a shift between the position of the target detected by the position detection device and the shooting direction of the bullet based on the direction instructed from the input device.

2. The game machine of claim 1, wherein
the shift controlling device operates to eliminate the shift by setting a direction in which the target is positioned, as a reference direction, based on the position of the target and the direction instructed from the input device and determining the shooting direction of the bullet based on the reference direction.

3. The game machine of claim 1, wherein
the direction determination device generates a shot range of a predetermined size, centered on a base point on the direction instructed from the input device, and when the target is present in the shot range, the position detection device detects the position of the target.

4. The game machine of claim 3, wherein
the position detection device detects the position of the target which is present in the shot range when the player shoots a bullet.

5. The game machine of claim 3, wherein
the position detection device detects the position of the target which is closest to a position of a character operated by the player when a plurality of targets are present in the shot range.

6. The game machine of claim 3, wherein
the direction determination device changes the size of the shot range based on game data showing the skill degree of the player.

7. The game machine of claim 2, wherein
the direction determination device generates a shot range of a predetermined size, centered on a base point on the direction instructed from the input device, and when the target is present in the shot range, the position detection device detects the position of the target.

8. The game machine of claim 7, wherein
the position detection device detects the position of the target which is present in the shot range when the player shoots a bullet.

9. The game machine of claim 7, wherein
the position detection device detects the position of the target which is closest to a position of a character operated by the player when a plurality of targets are present in the shot range.

10. The game machine of claim 7, wherein
the direction determination device changes the size of the shot range based on game data showing the skill degree of the player.

11. The game machine of claim 2, wherein
the direction determination device further has an accuracy calculation device which calculates accuracy which represents the shooting direction of the bullet as a probability distribution in the reference direction.

12. A storage medium storing a computer program for a computer of a game machine to function as:
a direction determination device which determines a shooting direction of a bullet based on a direction instructed from an input device;
a position detection device which detects the position of a target in the direction instructed from the input device; and
a shift controlling device which controls a shift between the position of the target detected by the position detection device and the shooting direction of the bullet based on the direction instructed from the input device.
